(19) United States
(12) Patent Application Publication
(10) Pub. No.: US 2007/0018429 A1
(43) Pub. Date: Jan. 25, 2007

(54) Foldable trailer with joint hinge and cantilever mechanism

(76) Inventor: Clark Randall, Dallas, TX (US)

Correspondence Address: Michael Cameron, 2025 Savannah Drive, McKinney, TX, 75070, US

(21) Appl. No.: 11/484,310

(22) Filed: Jul. 12, 2006

Related U.S. Application Data
(60) Provisional application No. 60/701,131, filed on Jul. 22, 2005.

(51) Int. Cl. B60D 1/54

(52) U.S. Cl. 280/491.1

(57) ABSTRACT

A folding trailer having a load bearing chassis supported by at least one pair of road wheels, the load bearing chassis being formed in two sections which are foldable between a first position in which the sections lie in a common plane and a second position in which the sections lie in parallel planes, facing outward. When in the second position the trailer can be moved into a substantially vertical plane for stowage. The joint formed between the rear perimeter of the front section and the front perimeter of the back section further have a cantilever portion adapted to strengthen the joint when a load is placed on the load bearing chassis.

### CROSS REFERENCE TO RELATED APPLICATION

This application claims the benefit of U.S. Provisional Application No. 60/701,131 filed on Jul. 22, 2005, entitled “FOLDABLE TRAILER WITH JOINT HINGE AND CANTILEVER SYSTEM. ”

### TECHNICAL FIELD

The present invention relates to trailers, and in particular, to a folding trailers having a joint hinge and cantilever mechanism.

### BACKGROUND OF THE INVENTION

Small trailers have long been manufactured for hauling items including building materials, such as lumber, sheetrock, and the like, lawn equipment, small tractors, motorcycles, ATVs and snowmobiles. Many of these small trailers are approximately 8 feet long times by 5 feet wide.

Trailers must be stored when they are not being used. This is often an inconvenience for a homeowner who owns a small trailer, as the trailer must often be stored in a garage. Attempts have been made to make trailers which fold for more compact storage. These conventional folding trailers have disadvantages, such as no sides or complex mechanical assemblies. One such trailer requires removal of the sides for folding. All of the identified conventional trailers are constructed such that when they are folded, the two sections of the top side of the trailer bed face each other. As such, the sides or side rails must be removed or otherwise configured so that one side or side rail can fold inside the other, resulting in reduced trailer bed space. Furthermore, such folding trailers have minimal structural strength at the hinge joint when a load is placed on the trailer bed.

### SUMMARY OF THE INVENTION

The present invention comprises a trailer including a load bearing chassis, at least one pair of road wheels mounted on at least one axle coupled to the load bearing chassis, via, for example, leaf springs, to support the load bearing chassis; a trailer bed and/or modular mounting system mountable on the load bearing chassis or chassis bed; the load bearing chassis being formed in two sections, a front section and a back section, the two sections being foldable between a first position in which the two sections lie in a substantially common plane and a second position in which the two sections are placed in substantially parallel planes; a unique cantilever and hinge system (including a continuous hinge) at the joint forming the front section and the back section; a winch and cable assembly that is operable to cause the two sections of the load bearing chassis to be pulled together into an upright position; a set of casters at the rear of the back section of the load bearing chassis and a support wheel system at the front of the front section of the load bearing chassis proximate the draw bar; and a separately hinged draw bar extending from the front end of the front section of the load bearing chassis, substantially perpendicular to the axle line of the axle(s) for connection to a towing vehicle, the draw bar being responsively pivoted around a hinged connection into the trailer when folded via a second cable that couples the draw bar to the rear of the trailer. The present invention is not limited to a folded trailer of any particular dimensions.

To those skilled in the art to which this invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

For a better understanding of the present invention including the features, advantages and specific embodiments, reference is made to the following detailed description along with accompanying drawings in which:

FIG. 1 is a perspective view of the trailer of the present invention in the unfolded position;

FIG. 2 is an underneath perspective view of the trailer of the present invention in the unfolded position;

FIG. 3 is a first perspective view of the trailer of the present invention in an intermediate folded position;

FIG. 4 is a second perspective view of the trailer of the present invention in an intermediate folded position;

FIG. 5 is a third perspective view of the trailer of the present invention in an intermediate folded position;

FIG. 6 is a perspective view of the trailer of the present invention in the folded position;

FIG. 7 is a close-up perspective view of the joint hinge and cantilever of the trailer of the present invention;

FIG. 8 is a close-up perspective view of the hinged draw bar of the trailer of the present invention;

FIG. 9 is a close-up perspective view of the winch of the trailer of the present invention;

FIG. 10 is a first side view of the joint hinge and cantilever of the trailer of the present invention;

FIG. 11 is a second side view of the joint hinge and cantilever of the trailer of the present invention; and

FIG. 12 is a third side view of the joint hinge and cantilever of the trailer of the present invention.

References in the detailed description correspond to like references in the Figures unless otherwise noted. Like numerals refer to like parts throughout the various Figures.

### DETAILED DESCRIPTION OF A PREFERRED EMBODIMENT

While the making and using of the preferred embodiment of the present invention is discussed in detail below, it should be appreciated that the present invention provides many applicable inventive concepts which can be embodied in a wide variety of specific contexts. Some features of the preferred embodiment shown and discussed may be simplified or exaggerated for illustrating the principles of the invention.

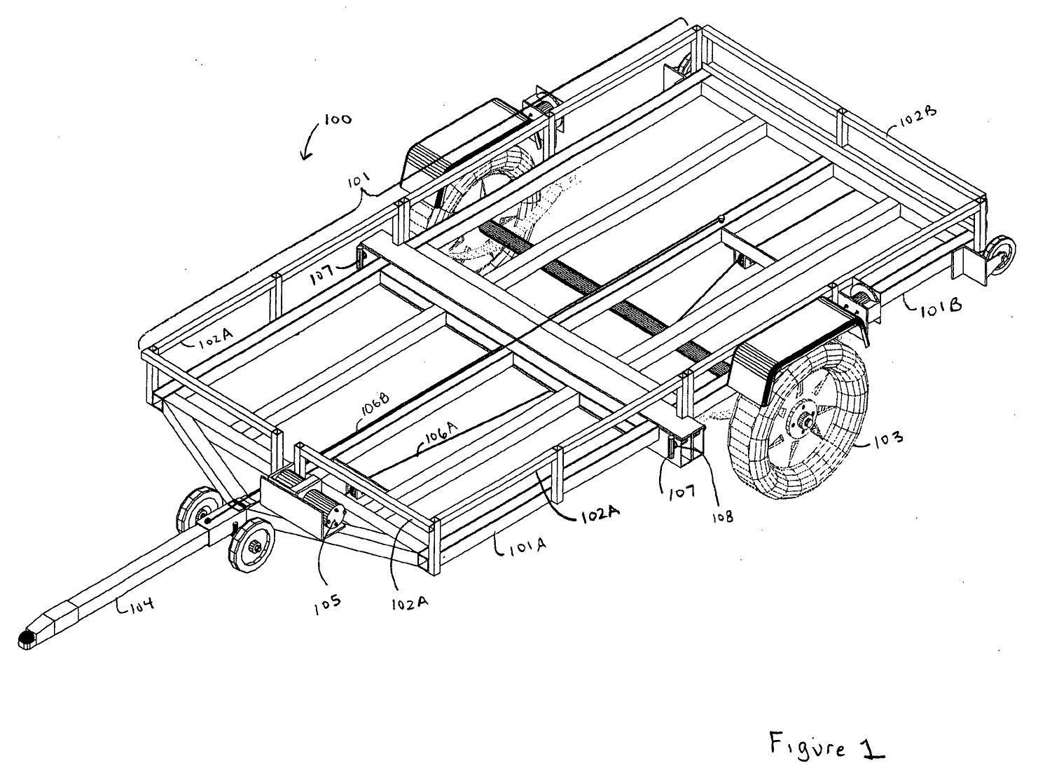

Referring now to FIG. 1, a trailer 100 having a load bearing chassis 101 being in two sections, front section 101A and back section 101B is provided. Trailer 100 is foldable between a first position in which the two sections 101A, 101B lie in a substantially common plane, and a second position in which the sections 101 A, 101 B lie in substantially parallel planes, the trailer bed resting on the load bearing chassis 101 facing outward. Side rails 102A are mounted on the outer perimeter of the load bearing chassis 101 along the left side, right side and front end of front section 101 A and gate rail 102B is located on the outer perimeter of the rear of back section 101B of load bearing chassis 101. The plane of the side rails 102A and gate rail 102B are orthogonal to the plane of a trailer bed resting on load bearing chassis 101. A pair of wheels 103 is further provided to support the load bearing chassis 101 above the ground as is a hinged draw bar 104 which extends from the front end of load bearing chassis 101 and being substantially perpendicular to the axis of the wheel axle(s). Hinged draw bar 104 provides an operative connection whereby the trailer 100 may be towed by a vehicle. The hinged draw bar 104 is adapted to be responsively pivoted around a hinged connection into trailer 100 when folded via a second cable 106B that couples draw bar 104 to the rear of the trailer 100. A variety of mounting mechanisms can be coupled to the bed of the chassis to secure loads placed on the bed. Such mechanisms can be adapted to hold loads such as motorcycles, ATVs, watercraft, machinery, building supplies and the like.

Winch and cable assembly comprises winch 105 and cable 106A and related connection points and pulleys. The terminal end of cable 106A is coupled to the rear of back section 101B of the trailer 100. As seen in FIG. 1, when the trailer is fully open, the hinge beam is secured with a ¾ inch steel pin 107 through pin aperture 108. Steel pin 107 is removed prior to folding the trailer.

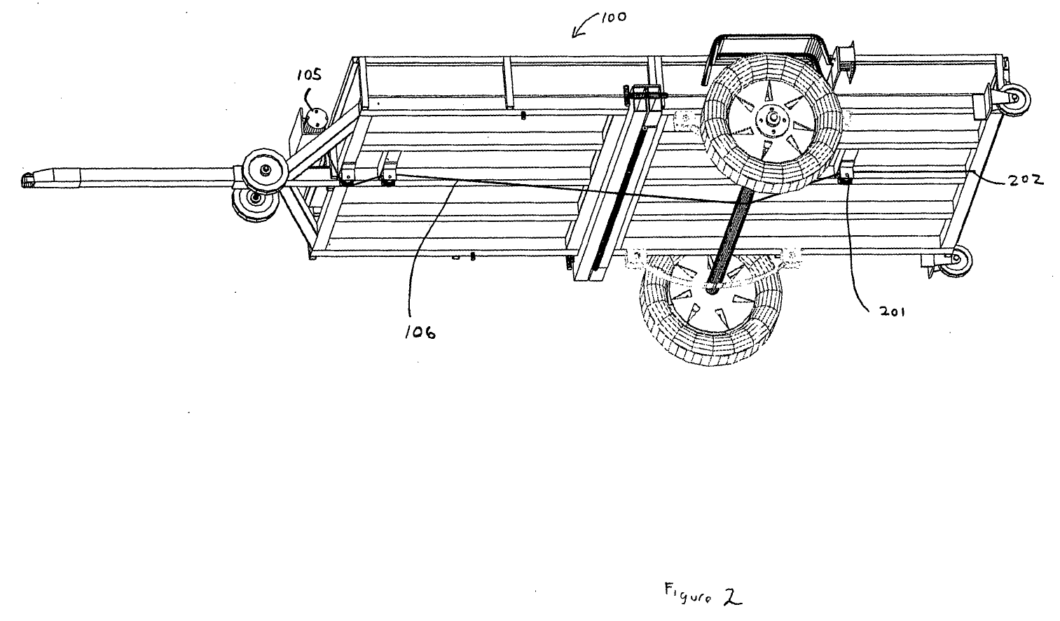

FIG. 2 provides an underneath perspective view of the trailer of the present invention in the unfolded position. As seen in the FIG. 2, cable 106A extends from winch 105 through pulley 201 to termination point 202 at the rear of back section 101B of the trailer 100. Termination point 202 can comprise an eyelet, screw or other coupling means.

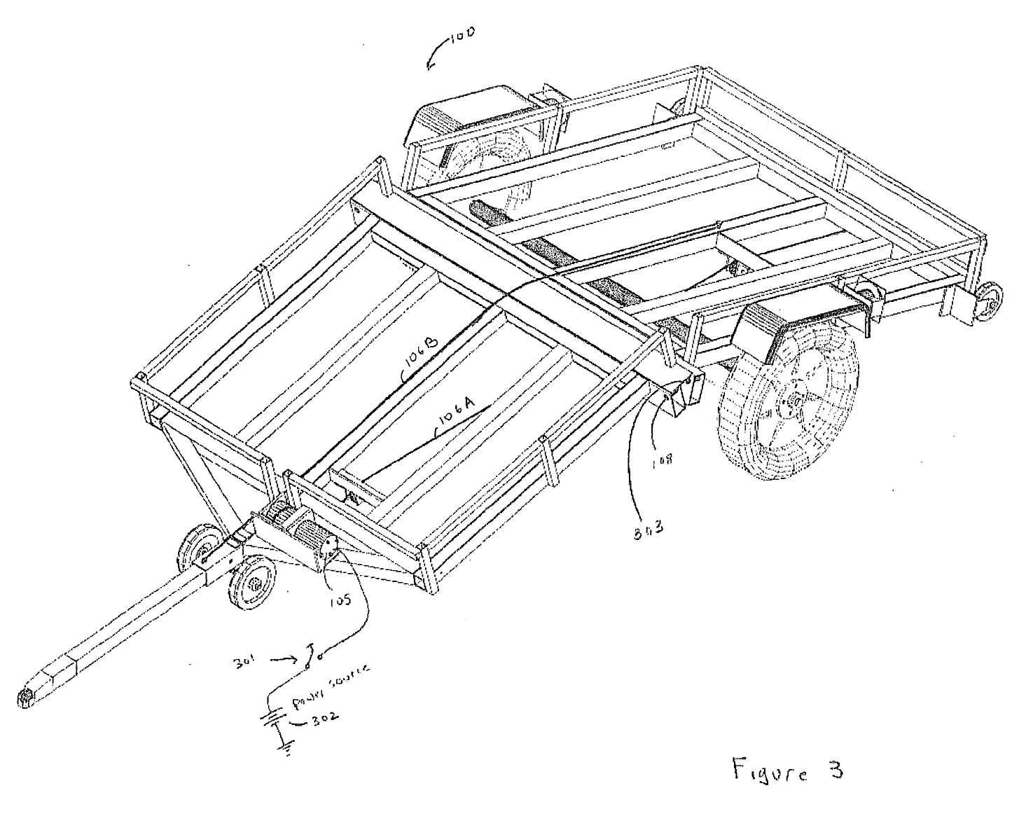

FIG. 3 provides a first perspective view of the trailer 100 of the present invention in an intermediate folded position. As seen therein, electrical winch 105 automatically folds the trailer with the push of a button 301 which couples power source 302 to the winch 105. As the trailer 100 is unfolded, a better view of cantilever 303 comes into view.

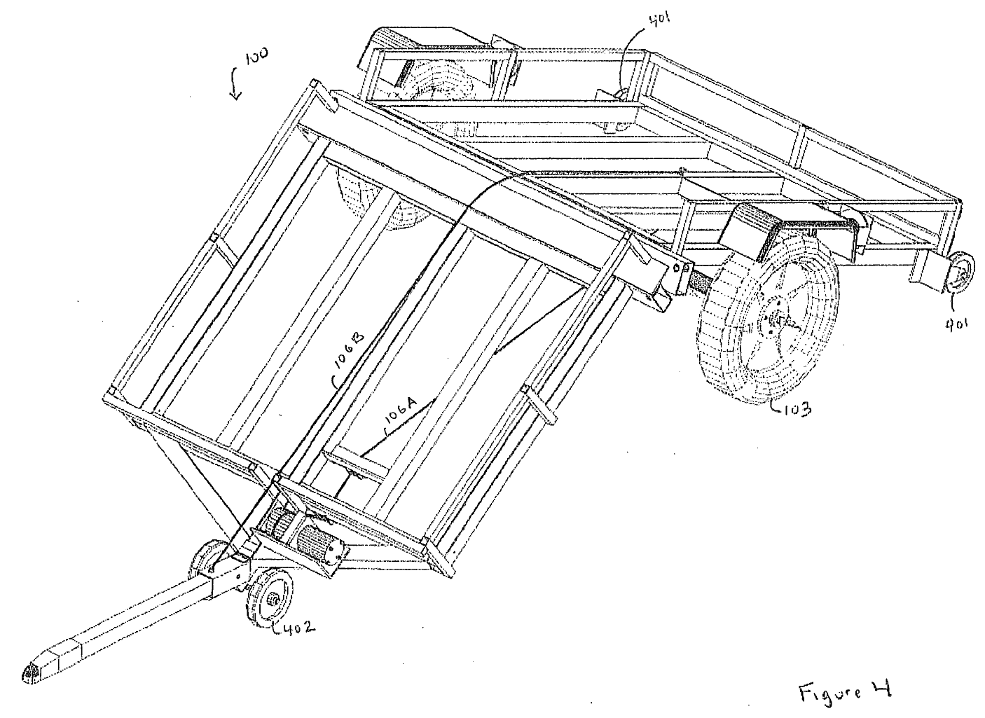

FIG. 4 provides a second perspective view of the trailer 100 of the present invention in an intermediate folded position. As seen therein, as the trailer is folding, the weight of the trailer is transferred from wheels 103 to casters 401 on the back section 101B and support wheels 402 on the front section 101A of the trailer 100. The casters can be located anywhere that is convenient or desirable along the back section 101B.

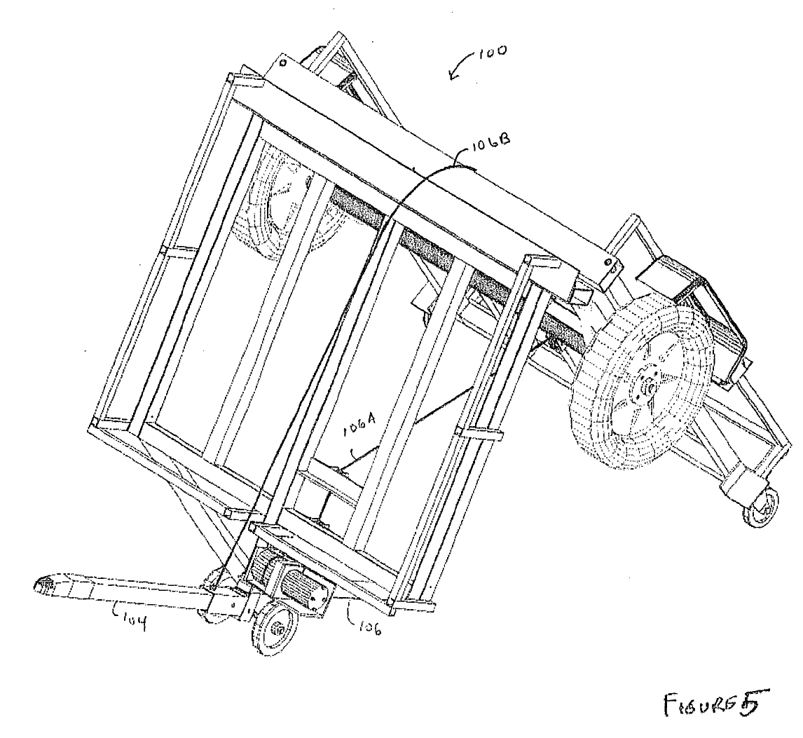

FIG. 5 provides a third perspective view of the trailer 100 of the present invention in an intermediate folded position. As seen therein, the draw bar 104 is responsively pivoted around hinged connection 801 into the body of the trailer 100 via cable 106B which is secured to the rear section 101B of trailer 100.

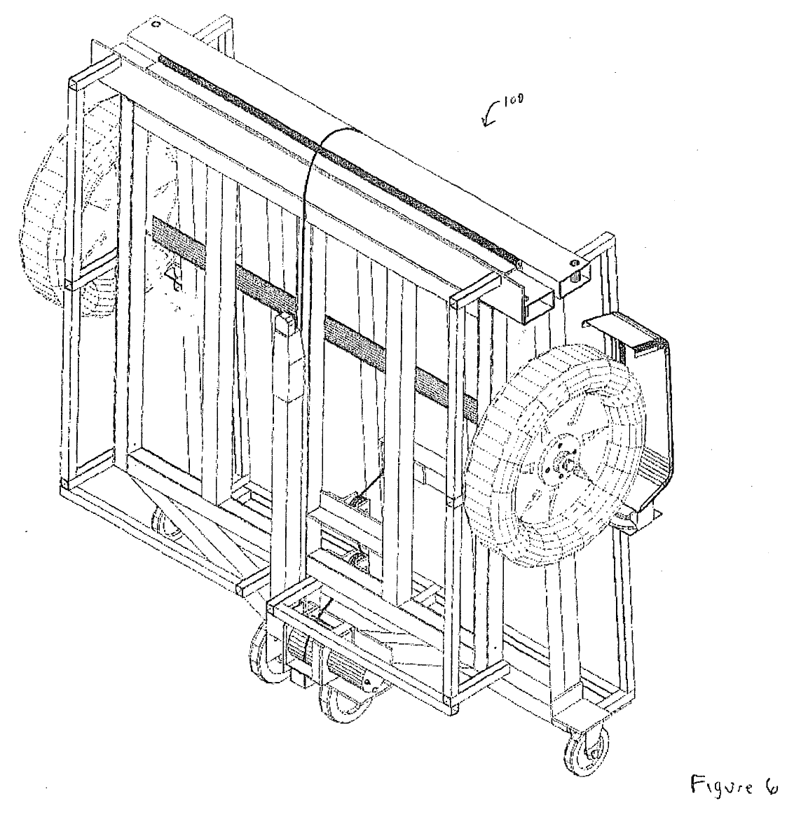

FIG. 6 provides a perspective view of the trailer 100 of the present invention in the folded position. In an embodiment of the present invention, trailer 100 only takes up 24″×60″ of floor space.

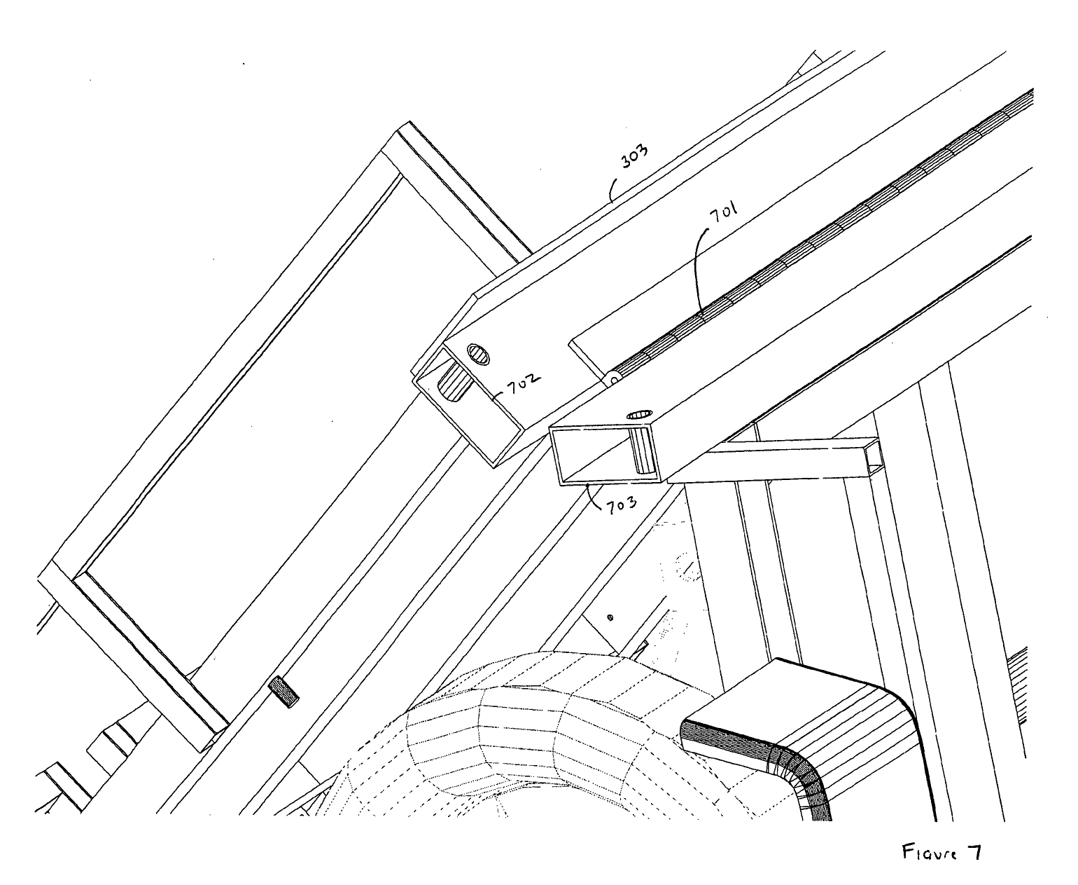

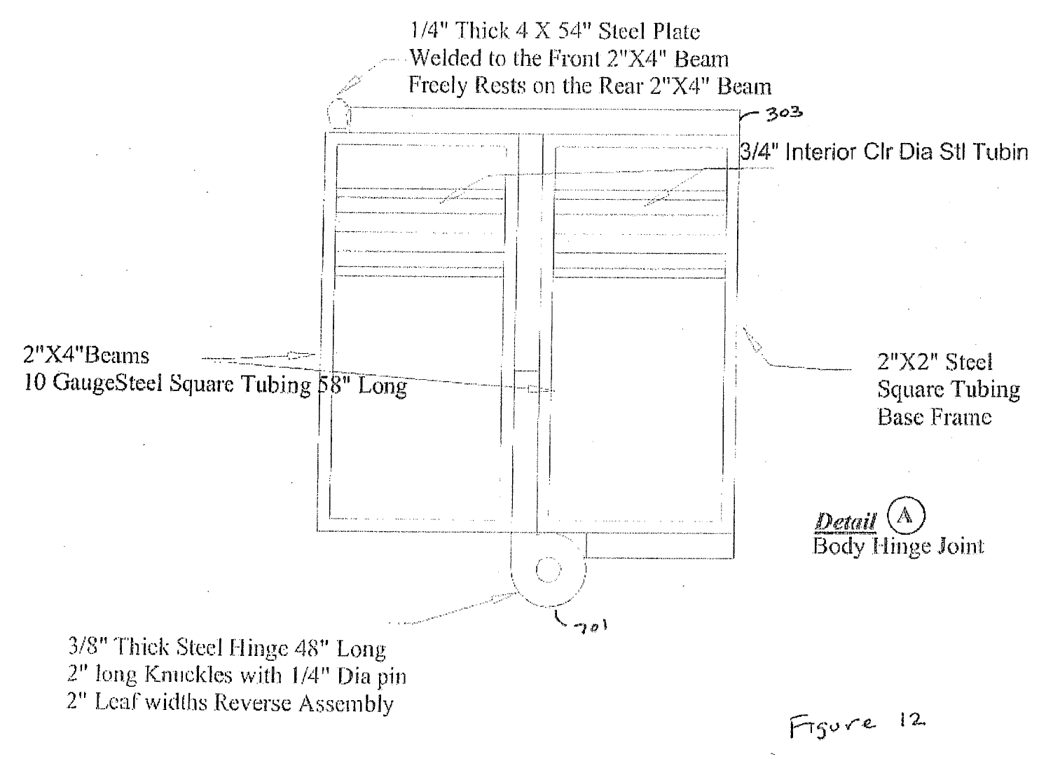

FIG. 7 provides a close-up perspective view of the joint hinge 701 which is a hinge, such as a continuous hinge, coupling the rear perimeter 702 of front section 101A and front perimeter 703 of back section 101B of trailer 100. The rear perimeter 702 of front section 101 A and the front perimeter 703 of back section 101B can comprise 2″×4″ beams of 10 gauge steel square tubing, approximately 58″ long, as seen in FIG. 12. In one embodiment, cantilever 303, which can comprise a ¼ inch thick steel plate is coupled, via welding or other coupling means, to the top of rear perimeter 702 of the front section 101A of trailer 100. In another embodiment, cantilever 303 is coupled, via welding or other coupling means, to the top of front perimeter 703 of the back section 101B of trailer 100.

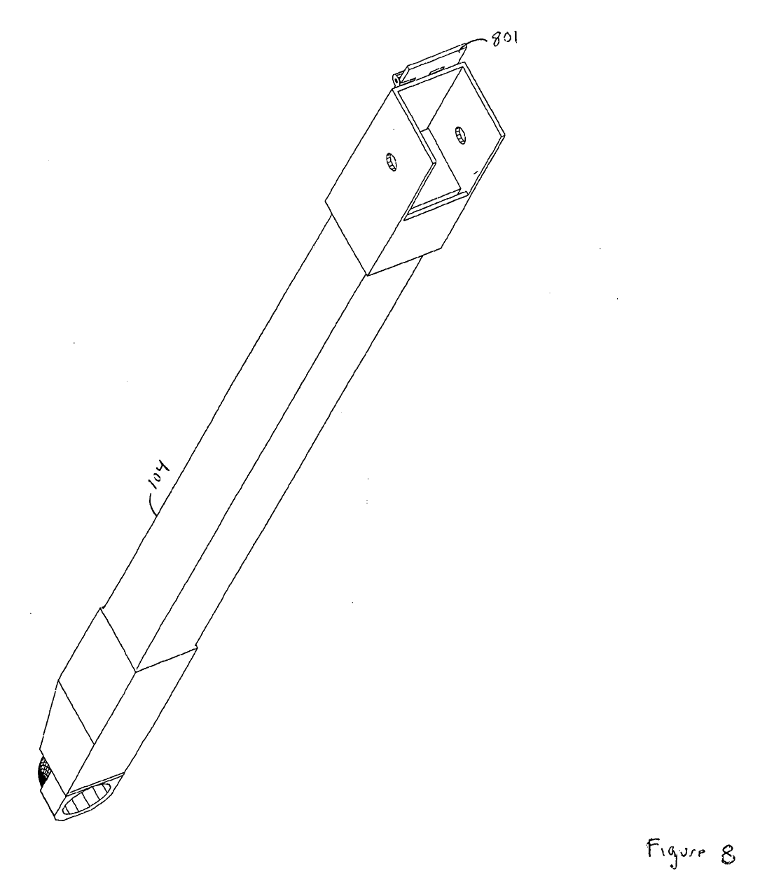

FIG. 8 provides a close-up perspective view of the hinged draw bar 104 of the trailer 100 of the present invention with hinged connection 801. Hinged draw bar 104 is responsively pivoted around hinged connection 801 into trailer 100 when folded via second cable 106B that couples draw bar 104 to the rear of the trailer 100.

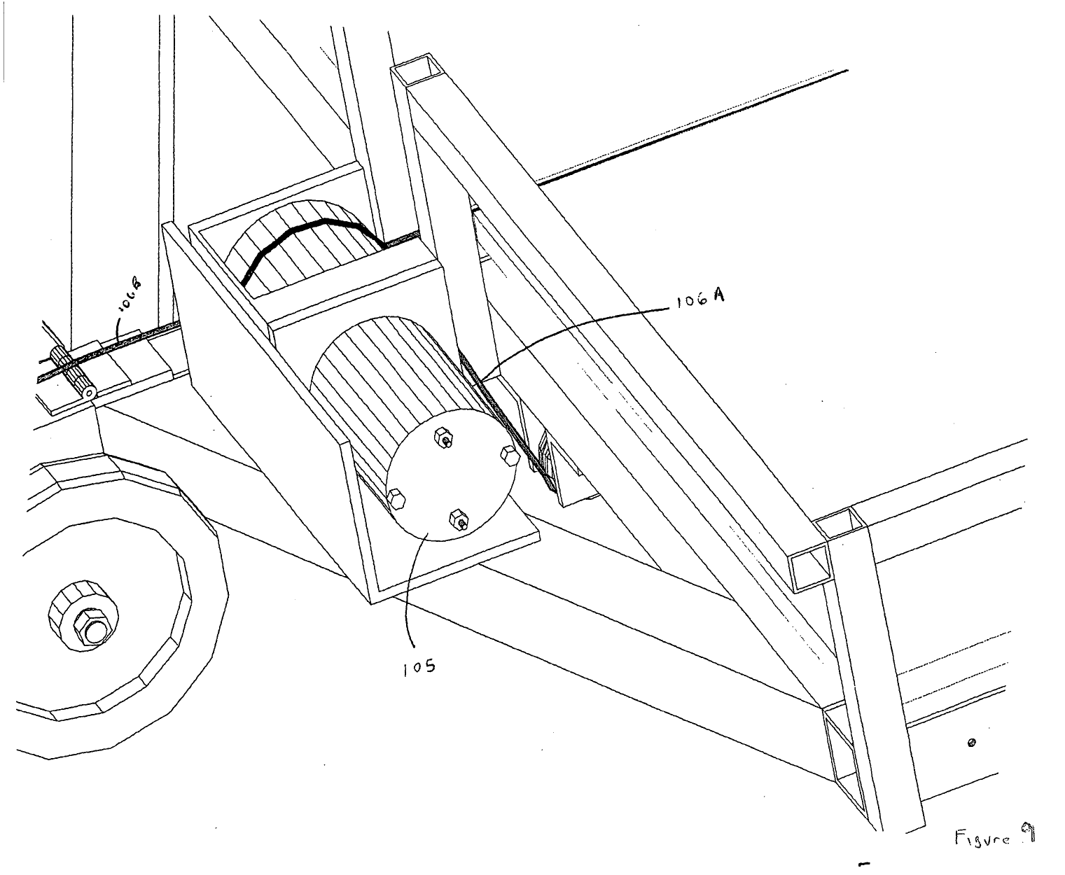

FIG. 9 provides a close-up perspective view of the winch 105 and cable 106A mechanism of the trailer 100 of the present invention.

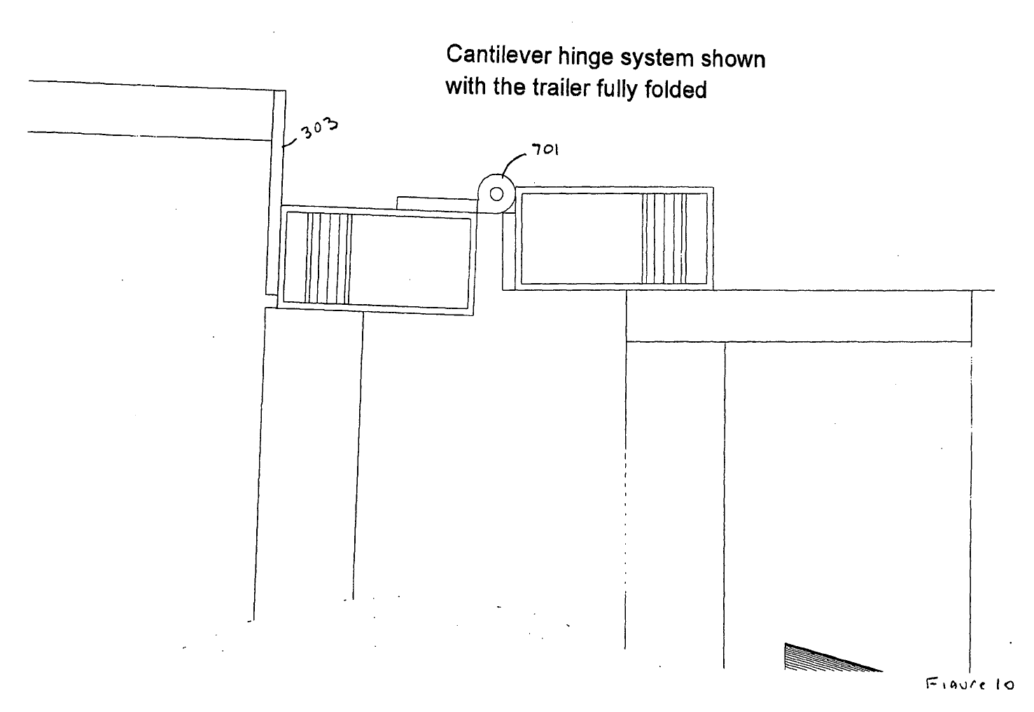

FIG. 10 provides a first side view of continuous joint hinge 701 and cantilever 303 of the trailer 100 of the present invention. In this view, the joint hinge 701 and cantilever 303 are shown with the trailer 100 fully folded.

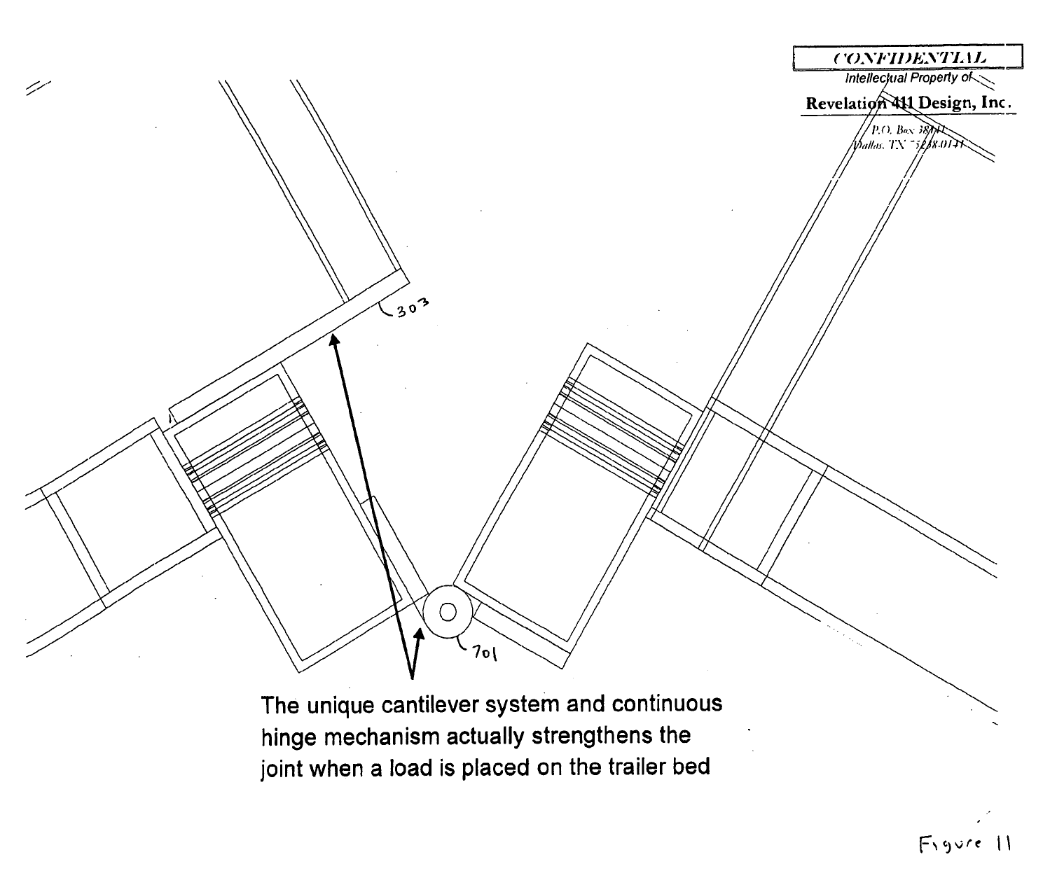

FIG. 11 provides a second side view of the continuous joint hinge 701 and cantilever 303 of the trailer 100 of the present invention. As seen therein, the unique cantilever 303 and continuous hinge 701 mechanism strengthens the joint when a load is placed on the load bearing chassis 101.

FIG. 12 provides a third side view of the joint hinge 701 and cantilever 303 of the trailer 100 of the present invention. This figure provides certain parameters of the unique joint hinge and cantilever system used in the trailer of the present invention.

It will further be appreciated that at least in the preferred embodiment as described herein, a folding trailer construction is provided in which the parts combine to provide interlocking not only in the folded configuration but also in the unfolded configuration and further the draw bar mounting not only facilitates the folding operation but further feeds the loads directly into the chassis of the vehicle and avoids high towing stresses on the load bearing parts of the construction.

The embodiments shown and described above are only exemplary. Even though numerous characteristics and advantages of the present invention have been set forth in the foregoing description together with details of the method of the invention, the disclosure is illustrative only and changes may be made within the principles of the invention to the full extent indicated by the broad general meaning of the terms used in the attached claims.

What is claimed is:

1. A trailer, comprising:
a load bearing chassis comprised of a front section and a back section, each of such sections having a top side on which a load can be placed;
at least one axle adapted to accept wheels, the axle coupled to either of the front section or the back section of the load bearing chassis;
a moveable hinge coupling a rear perimeter of the front section to a front perimeter of the back section, the hinge being adapted to permit the front section and back section to be folded such that when the trailer is placed in a folded position and the top sides of the front section and back section face outward; and
a joint formed between the rear perimeter of the front section and the front perimeter of the back section further having a cantilever portion adapted to strengthen the joint when a load is placed on the load bearing chassis.

2. The trailer of claim 1, wherein the hinge comprises a continuous hinge coupling the front section to the back section.

3. The trailer of claim 1, further comprising:
a winch and cable assembly responsively coupling the front section and back section of the load bearing chassis; and
the hinge being drawn upward as the cable is retracted by the winch.

4. The trailer of claim 3, wherein the winch is one selected from the group consisting of a hand operated winch and an electric powered winch.

5. The trailer of claim 1, further comprising a mounting mechanism coupled to the bed of the chassis adapted to secure loads placed on the bed.

6. The trailer of claim 1, wherein the cantilever portion is coupled along the rear of the front section, the cantilever adapted to rest on the front of the back section when the trailer is in the unfolded position.

7. The trailer of claim 6, wherein the cantilever portion comprises a steel plate welded to the rear of the front section and wherein the front of back section further comprises steel square tube beams.

8. The trailer of claim 1, wherein the cantilever is coupled along the front of the back section, said cantilever adapted to rest on the rear of the front section when the trailer is in the unfolded position.

9. The trailer of claim 8, wherein the cantilever portion comprises a steel plate welded to the front of the back section and wherein the back of the front section further comprises steel square tube beams.

10. The trailer of claim 1, further comprising a pair of wheels disposed on a single axle adapted to support, via leaf springs, the back section, to support a portion of the load on the back section.

11. The trailer of claim 1, further comprising two axles coupled to the chassis via leaf springs, adapted to support the back section to support a portion of the load on the back section.

12. The trailer of claim 1, further comprising a hinged draw bar extending from the front section of the load bearing chassis, the hinged draw bar being substantially perpendicular to the axis of the axle and adapted to enable engagement of the trailer with a towing vehicle.

13. The trailer of claim 12, further comprising the hinged draw bar being adapted to be pivoted into the body of the trailer as the trailer is folded into the folded position.

14. The trailer of claim 1, further comprising a set of casters coupled to the rear of the back section and at least one support wheel coupled to the front of the front section of the load bearing chassis, the casters and at least one support wheel operable to support the trailer when it is in the folded position.

15. A folding trailer, comprising:
a load bearing chassis comprised of a front section and a back section;
a continuous hinge connecting said front section and back section; and
a plate forming a cantilever welded to the rear of the front section, the cantilever adapted to rest on the front of the back section when the trailer is in the unfolded position.

16. The folding trailer of claim 15, further comprising at least one axle coupled, via leaf springs, to the bottom of the chassis.

17. The folding trailer of claim 16, further comprising a hinged draw bar extending from the front section of the load bearing section substantially perpendicular to the axis of the at least one axle, the hinged draw bar adapted to be folded when the trailer is in the folded position.

18. A method of coupling a front section of a foldable trailer to a back section of the foldable trailer, comprising:
coupling the front section to the back section with a hinge being adapted to permit the front section and back section to be folded such that the top sides of the front section and back section face outward when in the folded position; and
resting a plate welded along the rear portion of the front section on a front portion of the back section when the trailer is in the unfolded position.

19. The method of claim 18, further comprising coupling a winch and cable assembly between the front section and back section of the load bearing chassis.

20. The method of claim 19, further comprising drawing the hinge upward as the cable is retracted by the winch.
